(19) United States
(12) Patent Application Publication
(10) Pub. No.: US 2018/0075477 A1
(43) Pub. Date: Mar. 15, 2018

(54) USING MARKETPLACE CONSTRAINTS FOR ADVERTISEMENT BIDDING

(71) Applicant: Facebook, Inc., Menlo Park, CA (US)

(72) Inventor: Anand Sumatilal Bhalgat, Mountain View, CA (US)

(21) Appl. No.: 15/265,564

(22) Filed: Sep. 14, 2016

(51) Int. Cl. G06Q 30/02

(52) U.S. Cl. CPC G06Q 30/0246; G06Q 30/0276; G06Q 30/0275

(57) ABSTRACT

An online system presenting advertisement content determines a bid amount for an advertisement for each new impression opportunity based on a budget for an advertising campaign provided by the advertiser, pacing bid amounts to spend the budget over the course of the advertising campaign. The online system applies an additional constraint that limits a cost metric for the advertising campaign such as an observed CPM (cost per thousand impressions) to a multiple of an average CPM for a target audience for presentation of advertisements of the advertising campaign. To compute the average CPM for the target audience, the online system samples users in the target audience and retrieves an average CPM for each online system user, and averages the retrieved per-user average CPMs.

### BACKGROUND

This disclosure relates generally to optimizing an advertisement bidding process, and more specifically to using marketplace constraints for an advertisement bidding process.

An online system, such as a social networking system, allows its users to connect to and communicate with other online system users. Users may create profiles on an online system that are tied to their identities and include information about the users, such as interests and demographic information. The users may be individuals or entities such as corporations or charities. Because of the increasing popularity of online systems and the increasing amount of user-specific information maintained by online systems, an online system provides an ideal forum for entities to increase awareness about products or services by presenting content items to online system users.

Presenting content items to online system users allows an entity to gain public attention for products or services or to persuade online users to take an action regarding the entity's products or services. Additionally, many online systems generate revenue by displaying certain content items to their users. Frequently, online systems charge entities for each presentation of certain types of content items to an online system user (e.g., each “impression” of the certain types of content items) or for each interaction with certain types of content items by an online system user. The display of an advertisement to a viewer of the advertisement is referred to herein as an advertising “impression.”

Online services, such as social networking systems, search engines, news aggregators, Internet shopping services, and content delivery services, have become a popular venue for presenting advertisements to prospective buyers. Some online services provide their services free of charge or charge only minimal fees. Instead, the online services generate revenue by presenting advertisements to users, who may take certain actions based on the presented advertisements (e.g., clicking on the advertisements). The advertisement-based online service model has spawned many diverse types of online services.

Online services often use a scheme that charges advertisement fees commensurate with the number of times the advertisements are displayed to the users or actions taken by the users in response to viewing the advertisements. The pricing structure widely used in online services for assessing advertisement fees includes, for example, Cost Per Impression (CPI), Cost Per Action (CPA), and Cost Per Thousand Impressions (Cost Per Mille or CPM). The CPI-based pricing structure assesses advertisement fees based on the number of instances an advertisement is loaded and displayed on a user's screen, typically in response to a user's request for a content item. The CPA-based pricing structure assesses advertisement fees based on actions taken by the users after the advertisements are displayed on the screen. The actions taken into account for the CPA-based pricing structure may include, among others, the following: (i) clicking on the advertisement, (ii) registration to the advertiser's service or product and (iii) conclusion of a sale of a service or product. The CPM-based pricing structure assesses advertisement fees based on dividing the cost of an advertising placement by the number of impressions (expressed in thousands) that it generates. The CPM can be used for comparing the relative efficiency of various advertising opportunities or media and in evaluating the overall costs of advertising campaigns. Rather than using CPI, CPM or CPA-based pricing structure, some online services charge a flat fee for displaying an advertisement for a certain amount of time.

Some online services adopt a bidding system that allows multiple advertisers to bid for advertisement space. When an advertisement is required for a particular advertisement space, the advertisement with the highest bidding price is selected and presented in the advertisement space to maximize the advertisement fees. The bidding price may be based on CPI, CPA, CPM or other expected revenue values. The bidding system may also employ a cap for limiting the amount of advertisement fees for a set period of time (e.g., day or month). The context of an advertisement may affect the value of the advertisement to an advertiser, and accordingly, may affect the amount the advertiser is willing to bid for the advertisement.

Conventionally, during an advertising campaign, an advertiser provides to an online system a plurality of advertisements to be presented to one or more online system users (i.e., a target audience) under the advertising campaign. During the advertising campaign, bidding prices or bid amounts for advertisements can be paced such that a budget specified by the advertiser is spent during a time period of the advertising campaign. However, the pacing of bid amounts may often provide unsatisfactory experience for the advertiser, especially if selected bid amounts are too high for the advertising campaign for which the range of expected users' actions (i.e., conversion events) have a high variance and a low probability.

### SUMMARY

An online system, such as a social networking system or an advertising system, receives information describing an advertising campaign (“ad campaign”) including a plurality of advertisements from an advertiser for presentation to a plurality of users of the online system (i.e., a target audience). The online system can determine, for each new impression opportunity, a bidding price or a bid amount for an advertisement of the ad campaign based on a budget constraint specified by the advertiser. The online system further applies an additional constraint that limits pacing of the bid amount based on a multiple of an average Cost Per Thousand Impressions (Cost Per Mille or CPM) or expected CPM of the target audience. In some embodiments, for computing the average CPM for the target audience, the online system obtains (or samples) online system users who are in the target audience and retrieves their average CPM bids, which are maintained for each online system user. The online system then averages these obtained per-user average CPM bids to calculate an average CPM (or expected CPM) bid for the target audience. Thus, during the ad campaign, the online system pace bid amounts for advertisements of the ad campaign based on a budget constraint and a target-audience-average-CPM based constraint. This additional target-audience-average-CPM based constraint helps avoiding having an ad campaign with bad experience for the advertisers, which may result due to selection of inappropriate bid amounts for advertisements for which a range of expected online users' actions (i.e., conversion events) have a high variance and a low probability.

An online system, such as a social networking system, receives information for an ad campaign including a plurality of advertisements for presentation to a plurality of users of the online system (i.e., a target audience). The information for the ad campaign may specify at least one objective of the ad campaign. The online system receives a first constraint of the ad campaign specifying a budget for the ad campaign specifying an amount to be paid by an advertiser for the ad campaign during a time interval of the ad campaign. The online system estimates an amount to be paid by the advertiser for a set of impressions served to the plurality of users, and determines a second constraint of the ad campaign based on the estimated amount. The online system further determines a pacing multiplier associated with the ad campaign that controls the budget of the ad campaign and meeting the at least one objective of the ad campaign.

For each impression opportunity of plurality of impression opportunities identified to deliver an advertisement to the users of the online system, the online system determines a bid amount for the ad campaign based at least in part on the pacing multiplier factored into the bid determination such that an increase in the pacing multiplier increases the bid amount and a decrease in the pacing multiplier decreases the bid amount. The online system then provides the determined bid amount for the ad campaign to an advertisement selection process that selects one or more advertisements based on bids provided thereto, and delivers the one or more advertisements selected by the advertisement selection process to a user of the online system. During a plurality of different times during the time interval of the ad campaign, the online system compares an amount spent under the ad campaign against the specified budget for the ad campaign, to determine whether the ad campaign is on pace to reach the first constraint. The online system also compares an amount spent for a defined number of impressions served to the plurality of users during the ad campaign against the second constraint, to determine whether the ad campaign is on pace to reach the second constraint. Based on whether the ad campaign is on pace to reach the first constraint or the second constraint, the online system modifies the pacing multiplier to pace the bid amount for the advertisement.

### BRIEF DESCRIPTION OF THE DRAWINGS

FIG. 1 is a block diagram of a system environment in which an online system operates, in accordance with an embodiment.

FIG. 2 is a block diagram of an online system, in accordance with an embodiment.

FIGS. 3A and 3B illustrate a flowchart of a method for modifying a pacing multiplier and bid amounts of advertisements during an advertising campaign, in accordance with an embodiment.

FIG. 4 illustrates examples graphs of an amount of a budget spent under an advertising campaign and an observed Cost Per Thousand Impressions (Cost Per Mille or CPM) as a function of a bid amount paced during the advertising campaign, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

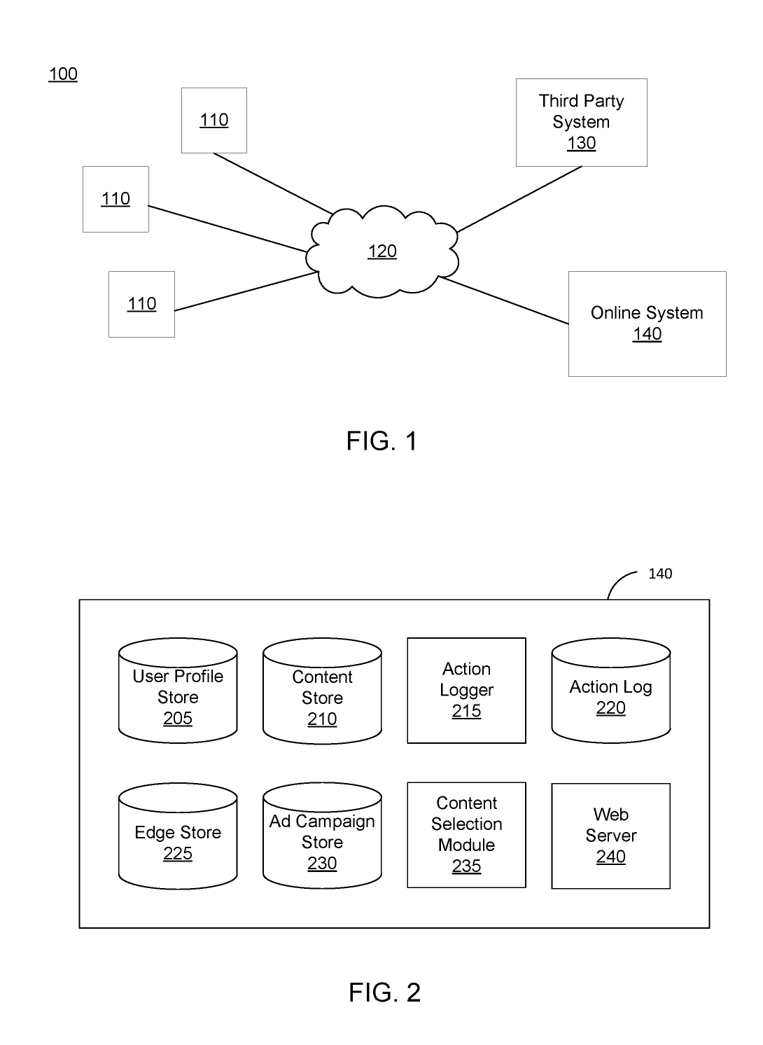

FIG. 1 is a block diagram of a system environment 100 for an online system 140. The system environment 100 shown by FIG. 1 comprises one or more client devices 110, a network 120, one or more third-party systems 130, and the online system 140. In alternative configurations, different and/or additional components may be included in the system environment 100. The embodiments described herein may be adapted to online systems that are social networking systems, content sharing networks, or other systems providing content to users.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone, a smartwatch or another suitable device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

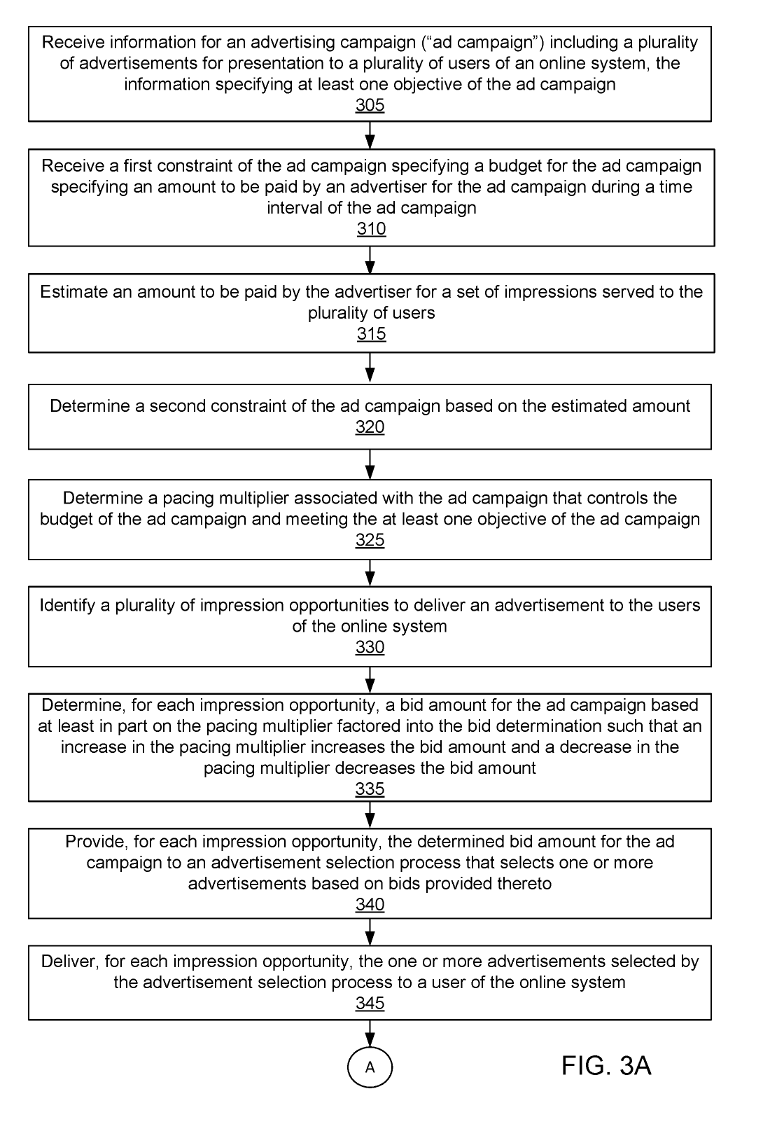

One or more third party systems 130 may be coupled to the network 120 for communicating with the online system 140, which is further described below in conjunction with FIG. 2. In one embodiment, a third party system 130 is an application provider communicating information describing applications for execution by a client device 110 or communicating data to client devices 110 for use by an application executing on the client device 110. In other embodiments, a third party system 130 provides content or other information for presentation via a client device 110. A third party system 130 may also communicate information to the online system 140, such as advertisements, content, or information about an application provided by the third party system 130.

In some embodiments, one or more of the third party systems 130 provide content to the online system 140 for presentation to users of the online system 140 and provide compensation to the online system 140 in exchange for presenting the content. For example, a third party system 130 provides advertisements of one or more advertising campaigns, which are further described below in conjunction with FIG. 2, including advertisements for presentation and amounts of compensation provided by the third party system 130 to the online system 140 in exchange to presenting the advertisements to the online system 140. Content presented by the online system 140 for which the online system 140 receives compensation in exchange for presenting is referred to herein as “sponsored content,” “sponsored content items,” or “advertisements.” Sponsored content from a third party system 130 may be associated with the third party system 130 or with another entity on whose behalf the third party system 130 operates.

FIG. 2 is a block diagram of an architecture of the online system 140. The online system 140 shown in FIG. 2 includes a user profile store 205, a content store 210, an action logger 215, an action log 220, an edge store 225, an advertisement (“ad”) campaign store 230, a content selection module 235, and a web server 240. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 205. A user profile includes declarative information about the user that was explicitly shared by the user and may also include profile information inferred by the online system 140. In one embodiment, a user profile includes multiple data fields, each describing one or more attributes of the corresponding online system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the online system users displayed in an image, with information identifying the images in which a user is tagged and stored in the user profile of the user. A user profile in the user profile store 205 may also maintain references to actions by the corresponding user performed on content items in the content store 210 and stored in the action log 220.

While user profiles in the user profile store 205 are frequently associated with individuals, allowing individuals to interact with each other via the online system 140, user profiles may also be stored for entities such as businesses or organizations. This allows an entity to establish a presence on the online system 140 for connecting and exchanging content with other online system users. The entity may post information about itself, about its products or provide other information to users of the online system 140 using a brand page associated with the entity's user profile. Other users of the online system 140 may connect to the brand page to receive information posted to the brand page or to receive information from the brand page. A user profile associated with the brand page may include information about the entity itself, providing users with background or informational data about the entity. In some embodiments, the brand page associated with the entity's user profile may retrieve information from one or more user profiles associated with users who have interacted with the brand page or with other content associated with the entity, allowing the brand page to include information personalized to a user when presented to the user.

The content store 210 stores objects that each represents various types of content. Examples of content represented by an object include a page post, a status update, a photograph, a video, a link, a shared content item, a gaming application achievement, a check-in event at a local business, a brand page, or any other type of content. Online system users may create objects stored by the content store 210, such as status updates, photos tagged by users to be associated with other objects in the online system 140, events, groups or applications. In some embodiments, objects are received from third-party applications or third-party applications separate from the online system 140. In one embodiment, objects in the content store 210 represent single pieces of content, or content “items.” Hence, online system users are encouraged to communicate with each other by posting text and content items of various types of media to the online system 140 through various communication channels. This increases the amount of interaction of users with each other and increases the frequency with which users interact within the online system 140.

The action logger 215 receives communications about user actions internal to and/or external to the online system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with the particular users as well and stored in the action log 220.

The action log 220 may be used by the online system 140 to track user actions on the online system 140, as well as actions on third party systems 130 that communicate information to the online system 140. Users may interact with various objects on the online system 140, and information describing these interactions is stored in the action log 220. Examples of interactions with objects include: commenting on posts, sharing links, checking-in to physical locations via a client device 110, accessing content items, and any other suitable interactions. Additional examples of interactions with objects on the online system 140 that are included in the action log 220 include: commenting on a photo album, communicating with a user, establishing a connection with an object, joining an event, joining a group, creating an event, authorizing an application, using an application, expressing a preference for an object (“liking” the object), engaging in a transaction, viewing an object (e.g., a content item), and sharing an object (e.g., a content item) with another user. Additionally, the action log 220 may record a user's interactions with advertisements on the online system 140 as well as with other applications operating on the online system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the online system 140. For example, an e-commerce website may recognize a user of an online system 140 through a social plug-in enabling the e-commerce website to identify the user of the online system 140. Because users of the online system 140 are uniquely identifiable, e-commerce web sites, such as in the preceding example, may communicate information about a user's actions outside of the online system 140 to the online system 140 for association with the user. Hence, the action log 220 may record information about actions users perform on a third party system 130, including webpage viewing histories, advertisements that were engaged, purchases made, and other patterns from shopping and buying. Additionally, actions a user performs via an application associated with a third party system 130 and executing on a client device 110 may be communicated to the action logger 215 by the application for recordation and association with the user in the action log 220.

In one embodiment, the edge store 225 stores information describing connections between users and other objects on the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page on the online system 140, sharing a link with other users of the online system 140, and commenting on posts made by other users of the online system 140.

In one embodiment, an edge may include various features each representing characteristics of interactions between users, interactions between users and objects, or interactions between objects. For example, features included in an edge describe a rate of interaction between two users, how recently two users have interacted with each other, a rate or an amount of information retrieved by one user about an object, or numbers and types of comments posted by a user about an object. The features may also represent information describing a particular object or a particular user. For example, a feature may represent the level of interest that a user has in a particular topic, the rate at which the user logs into the online system 140, or information describing demographic information about the user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online system 140 over time to approximate a user's interest in an object or in another user in the online system 140 based on the actions performed by the user. A user's affinity may be computed by the online system 140 over time to approximate the user's interest in an object, in a topic, or in another user in the online system 140 based on actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

One or more advertisement campaigns (“ad campaigns”) are included in the ad campaign store 230. An ad campaign includes a plurality of advertisements received from an advertiser for presentation to users of the online system 140. The ad campaign is associated with one or more objectives, a budget and duration. An objective associated with an ad campaign describes one or more goals for presentation of advertisements during the ad campaign. For example, an objective specifies a total number of impressions of advertisements to be delivered to the users of the online system 140 under the ad campaign during a time interval of the ad campaign. The budget specifies a total amount of compensation a user (e.g., an advertiser) associated with an ad campaign provides the online system 140 for presenting advertisements to the users of the online system 140.

Additionally, the duration associated with the ad campaign specifies a time interval during which advertisements are presented to social networking system users. For example, if the duration of an ad campaign is 30 days, advertisements included in the ad campaign are presented to online system users for 30 days after the ad campaign is provided to the online system 140. In some embodiments, the user providing the ad campaign may also specify a start date for the ad campaign, so the duration is measured from the specified start date.

An advertising campaign includes one or more advertisements for presentation to one or more social networking system users. An advertisement includes advertisement content and a bid amount. The advertisement is text, image, audio, video, or any other suitable data presented to a user. The advertisement may also include a landing page specifying a network address to which a user is directed when the advertisement content is accessed. In some embodiments, the bid amount is associated with an advertisement by a user providing the advertisement to the online system 140 and is used to determine an expected value, such as monetary compensation, provided by the user to the online system 140 if the advertisement is presented to another user, if the advertisement receives an interaction from another user presented with the advertisement, or if any suitable condition is satisfied when the advertisement is presented to another user. For example, the bid amount specifies a monetary amount that the online system 140 receives from an advertiser if an advertisement is displayed. In some embodiments, the expected value to the online system 140 of presenting the advertisement may be determined by multiplying the bid amount by a probability of the advertisement being accessed by a user.

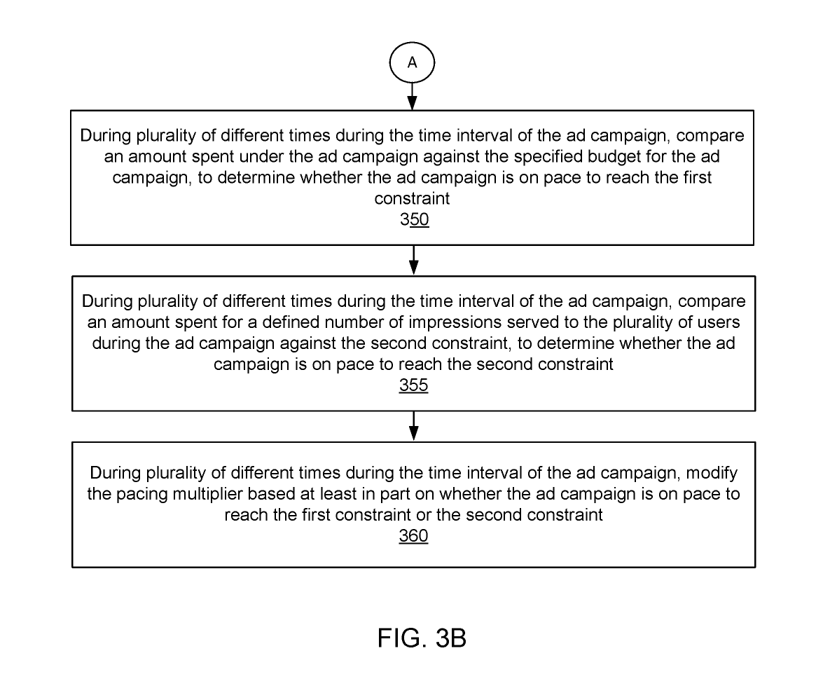

In various embodiments, the user (e.g., advertiser) providing an advertisement to the online system 140 does not associate a bid amount with the advertisement, but the online system 140 determines a bid amount for the advertisement based on a budget, a duration, or an objective associated with the ad campaign including the advertisement. For example, a pacing factor is determined from the budget associated with an ad campaign including the advertisement and an amount spent by an advertiser on the ad campaign from a start date of the ad campaign to a current time. The pacing factor modifies a bid amount associated with various advertisements in the ad campaign, altering spending of the ad campaign's budget throughout the duration of the ad campaign. In some embodiments, the advertiser specifies the budget (i.e., the budget constraint) for the ad campaign, and the online system 140 determines bid amounts of advertisements in the ad campaign based on the budget constraint and an additional constraint related to an average Cost Per Thousand Impressions (Cost Per Mille or CPM) for a target audience comprising one or more online system users to which the advertisements are to be delivered, as further described below in conjunction with FIGS. 3A and 3B.

In some embodiments, targeting criteria may be associated with the ad campaign in its entirety, so multiple advertisements in the ad campaign are associated with the targeting criteria. Additionally, an advertiser may specify targeting criteria associated with various individual ad requests in the ad campaign to associate different targeting criteria with various ad requests. Targeting criteria associated with an ad request specify one or more characteristics of users eligible to be presented with an ad creative included in the ad request. Associating different targeting criteria with different ad requests in the ad campaign allows an advertiser to tailor presentation of ad creatives to users having specific characteristics, allowing different ad creatives to be presented to users with different characteristics. For example, targeting criteria specify demographic information, connections, or actions associated with a user. In one embodiment, targeting criteria may specify actions or types of connections between a user and another user or object of the online system 140. Targeting criteria may also specify interactions between a user and objects performed external to the online system 140, such as on a third party system 130. For example, targeting criteria identifies users that have taken a particular action, such as sending a message to another user, using an application, joining a group, leaving a group, joining an event, generating an event description, purchasing or reviewing a product or service using an online marketplace, requesting information from a third party system 130, or any other suitable action. Including actions in targeting criteria allows advertisers to further refine users eligible to be presented with ad requests from an ad campaign. As another example, targeting criteria identifies users having a connection to another user or object or having a particular type of connection to another user or object.

The content selection module 235 selects one or more content items for communication to a client device 110 to be presented to a user. Content items eligible for presentation to the user are retrieved from the content store 210, from the ad campaign store 230, or from another source by the content selection module 235, which selects one or more of the content items for presentation to the user. A content item eligible for presentation to the user is a content item associated with at least a threshold number of targeting criteria satisfied by characteristics of the user or is a content item that is not associated with targeting criteria. In various embodiments, the content selection module 235 includes content items eligible for presentation to the user in one or more selection processes, which identify a set of content items for presentation to the user. For example, the content selection module 235 determines measures of relevance of various content items to the user based on characteristics associated with the user by the online system 140 and based on the user's affinity for different content items. Information associated with the user included in the user profile store 205, in the action log 220, and in the edge store 225 may be used to determine the measures of relevance. Based on the measures of relevance, the content selection module 235 selects content items for presentation to the user. As an additional example, the content selection module 235 selects content items having the highest measures of relevance or having at least a threshold measure of relevance for presentation to the user. Alternatively, the content selection module 235 ranks content items based on their associated measures of relevance and selects content items having the highest positions in the ranking or having at least a threshold position in the ranking for presentation to the user.

Content items selected for presentation to the user may include advertisements or other content items associated with bid amounts. The content selection module 235 uses the bid amounts associated with advertisements when selecting content for presentation to the viewing user. In various embodiments, the content selection module 235 determines an expected value associated with various advertisements (or other content items) based on their bid amounts and selects advertisements associated with a maximum expected value or associated with at least a threshold expected value for presentation. An expected value associated with an advertisement or with a content item represents an expected amount of compensation to the online system 140 for presenting an advertisement or for presenting the content item. For example, the expected value associated with an advertisement is a product of the advertisement's bid amount and a likelihood of the user interacting with the advertisement content. The content selection module 235 may rank advertisements based on their associated bid amounts and select advertisements having at least a threshold position in the ranking for presentation to the user. In some embodiments, the content selection module 235 ranks both content items not associated with bid amounts and advertisements in a unified ranking based on bid amounts associated with advertisements and measures of relevance associated with content items and with advertisements. Based on the unified ranking, the content selection module 235 selects content for presentation to the user. Selecting advertisements and other content items through a unified ranking is further described in U.S. patent application Ser. No. 13/545,266, filed on Jul. 10, 2012, which is hereby incorporated by reference in its entirety.

The web server 240 links the online system 140 via the network 120 to the one or more client devices 110, as well as to the one or more third party systems 130. The web server 240 serves web pages, as well as other content, such as JAVA®, FLASH®, XML and so forth. The web server 240 may receive and route messages between the online system 140 and the client device 110, for example, instant messages, queued messages (e.g., email), text messages, short message service (SMS) messages, or messages sent using any other suitable messaging technique. A user may send a request to the web server 240 to upload information (e.g., images or videos) that are stored in the content store 210. Additionally, the web server 240 may provide application programming interface (API) functionality to send data directly to native client device operating systems, such as IOS®, ANDROID™, WEBOS® or BlackberryOS.

Bidding Mechanism when Advertiser Cannot/does not Specify Bid Amount

FIGS. 3A and 3B illustrate a flowchart of one embodiment of a method for modifying a pacing multiplier and bid amounts of advertisements during an advertising campaign (“ad campaign”), in accordance with an embodiment. In various embodiments, the steps described in conjunction with FIGS. 3A and 3B may be performed in different orders than the order described in conjunction with FIGS. 3A and 3B. Additionally, the method may include different and/or additional steps than those described in conjunction with FIGS. 3A and 3B in some embodiments.

The online system 140 receives 305 information for an ad campaign including a plurality of advertisements for presentation to a plurality of users of the online system 140 (i.e., a target audience). In some embodiments, an advertiser may provide the information for the ad campaign including the plurality of advertisements to the online system 140. The information for the ad campaign may include instructions for determining bid amounts for advertisements in the ad campaign. For example, the information includes instructions for allocating a budget among advertisements in the ad campaign based on one or more criteria (e.g., an amount of the budget remaining, an amount of an objective that has been completed, an amount of a time interval of the ad campaign remaining, and so on).

The information for the ad campaign may further specify at least one objective of the ad campaign. The at least one objective of the ad campaign may be related to an advertiser's experience during the ad campaign. In an embodiment, the at least one objective of the ad campaign comprises a number of impressions to be delivered to the plurality of users under the ad campaign during a time interval of the ad campaign. In another embodiment, the at least one objective specifies a number of any suitable type of interaction by online system users with advertisements from the ad campaign (e.g., a number of accesses of advertisements from the ad campaign by online system users, a number of interactions with objects associated with at least one advertisement from the ad campaign, etc.) during a time interval of the ad campaign. Hence, the at least one objective may specify a number of interactions associated with advertisements from the ad campaign during a time interval of the ad campaign. If the information describing the ad campaign does not include an objective, the online system 140 may identify an objective associated with the ad campaign by requesting an objective from the advertiser or by inferring an objective based on a number or percentage of characteristics of the ad campaign matching other ad campaigns associated with the advertiser having an objective and inferring the objective as an objective associated with at least a threshold number of other ad campaigns associated with the advertiser having at least a threshold number or percentage of characteristics matching characteristics of the ad campaign.

The online system 140 receives 310 a first constraint of the ad campaign specifying a budget for the ad campaign specifying an amount to be paid by an advertiser for the ad campaign during a time interval of the ad campaign. In some embodiments, the advertiser provides the budget constraint for the ad campaign to the online system 140. However, the advertiser is not able to specify to the online system 140 any further information that can be used to determine bid amounts for the ad campaign. This may typically occur when the ad campaign features rare conversion events or events having a high variance of conversion rates. A low probability of conversion event and/or a high variance of conversion rates may lead to a high variance for bid amounts for advertisements of the ad campaign. In this case, the advertiser does not know what bid amount to propose for an advertisement since a marketplace does not have enough constraints that provide a reasonable experience for the advertiser. Thus, one goal of the online system 140 is to infer the right marketplace constraints to be able to determine appropriate bid amount for advertisements of the ad campaign.

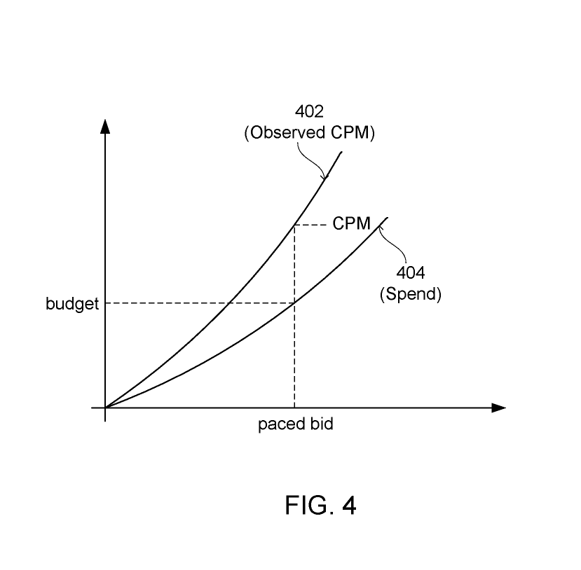

FIG. 4 illustrates examples graphs of an amount spent under an ad campaign and an observed CPM as a function of bid amounts paced during the ad campaign, in accordance with an embodiment. In some embodiments, an advertiser specifies only a budget constraint to the online system 140 due to weakly constraint marketplace specification. In this case, the advertiser can always keep bidding high enough so the budget is spent at the end of the ad campaign. As illustrated by the spend curve 402 in FIG. 4 that determines an amount spent under the ad campaign as a function of a paced bid amount during a time interval of the ad campaign, increasing a paced bid amount during an advertisement bidding process (auction) causes a spent amount of the budget also to increase, which can keep increasing until the spent amount reaches the budget constraint specified by the advertiser. However, increasing the paced bid amount during the advertisement bidding process until the budget constraint is reached may not provide the appropriate advertiser's experience, i.e., the at least one objectives of the ad campaign specified by the advertiser may not be achieved. As further illustrated in FIG. 4 by the CPM curve 404 that determines an observed CPM as a function of a paced bid amount during a time interval of the ad campaign, increasing a paced bid amount during the advertisement bidding process (auction) also causes the observed CPM for a time instant of the ad campaign to increase, which may further result in inappropriate advertiser's experience.

In some embodiments, the advertiser does not have enough information (e.g., does not have a knowledge about marketplace constraints) to determine an appropriate budget for a target audience (i.e., online system users) for presentation of advertisements of the ad campaign to the target audience. The advertiser may specify a budget and provide the budget constraint to the online system 140, wherein the specified budget is inadequate for a specific target audience. In an illustrative embodiment, an advertiser specifies to the online system 140 a budget constraint of $1,000 for 1,000 size target audience (i.e., 1,000 users of the online system 140). The advertiser may not know, but bidding $1.00 per online system user may be very large bidding price, and the specified budget may be spent without achieving an objective of an ad campaign related to, for example, a number of impressions to be delivered to the online system users under the ad campaign during a time interval of the ad campaign. Thus, delivery of advertisements for presentation to online system users should enforce right constraints of the ad campaign in order to provide an appropriate advertiser's experience during the ad campaign.

In some embodiments, delivery of an advertisement of the ad campaign is constrained based on a defined maximum bid amount. In this case, the online system 140 cannot pace a bid amount for the advertisement beyond the defined maximum bid amount. However, pacing the bid amount based on a budget constraint and a maximum bid amount constraint may not provide an equilibrium solution and may not result in an appropriate advertiser's experience during the ad campaign, i.e., certain objective(s) of the ad campaign may not be achieved (e.g., a number of impressions to be delivered to the online system users under the ad campaign during a time interval of the ad campaign cannot be reached). There are two main reasons why an advertisement bidding constraint based on the defined maximum bid amount does not provide the appropriate advertiser's experience. First, the advertiser desires to spend a budget having reasonable experiences during different ad campaigns, wherein bid amounts for advertisements are inferred by these experiences. Second, conversion events can be very dispersing, i.e., a variance of conversion rates can be very high.

In various embodiments, an expected conversion rate can have a certain bounded variance. In an illustrative embodiment, during an ad campaign, the best conversion rate can be, for example, 25%, wherein the worse conversion rate can be, for example, 5%. A bid amount suitable for 5% conversion rate is substantially similar to another bid amount suitable for 25% conversion rate, i.e., bid amounts are within a certain defined upper limit from each other when the range of conversion rates does not have a high variance. Thus, it is unlikely that cost-per-actions (i.e., bidding prices or bid amounts) are vastly different for different advertisers when the advertisers compete on events that are likely and have a narrow variance for conversion rates. This is however different if conversion events are much more disperse, i.e., when a variance of conversion rates is above a defined threshold. In this case, advertisers do not have enough information to determine appropriate bid amounts for advertisements, and cannot specify to the online system 140 any information related to determining bid amounts for advertisements of ad campaigns. Therefore, it is desirable for each advertiser and each ad campaign to determine a reasonable constraint for bid amounts that can finish a specified budget while achieving one or more objectives for the ad campaign. In some embodiments, one or more components of the online system 140 can be configured to infer one or more marketplace constraints and determine at least one additional constraint for an advertisement bidding process.

In an illustrative embodiment, an advertiser specifies to the online system 140 a budget constraint of $1,000 for 1,000 size target audience (i.e., 1,000 users of the online system 140), wherein an observed CPM during an ad campaign is $100. However, the observed CPM of $100 can be too high, and the budget would be spent without achieving one or more specified objectives of the ad campaign. For example, if the advertisement bidding was performed with smaller bid amounts, the advertiser would achieve 95% of reach with 20% of spent budget. Alternatively, if the advertisement bidding was performed with even smaller bid amounts, the advertiser would achieve 80% of reach with 5% of spent budget. Thus, it can be observed that the advertiser provides an extremely expensive reach for this particular target audience with the observed CPM of $100, which could be avoided with more appropriate pacing of bid amounts during an advertisement bidding process.

In the case of rare conversion events (i.e., events with a conversion probability below a certain threshold level), an advertiser may not have enough information to know how rare these conversion events are. Therefore, it can be challenging for the advertiser to determine an appropriate range of values for bid amounts. In some embodiments, the online system 140 is able to infer appropriate marketplace constraints. In the marketplace, an advertiser typically buys impression opportunities at auctions, i.e., during advertisement bidding processes. Thus, a CPM based constraint needs to be considered during the advertisement bidding process. In some embodiments, bid amounts can be paced such that an observed CPM over time during the ad campaign (i.e., represented by the curve 402 in FIG. 4), when bidding on a conversion event, is not larger than a defined multiple of an average CPM bid for a target audience, as further described below in conjunction with FIGS. 3A and 3B. This represents a preferred approach for the advertisement bidding process because, at the marketplace, everything occurs at a single impression level for the target audience. Thus, the audience-average CPM represents an appropriate constraint for pacing bid amounts during an advertisement bidding process.

The online system 140 estimates 315 an amount to be paid by the advertiser for a set of impressions served to the plurality of users (i.e., target audience). In some embodiments, the online system 140 estimates 315 the amount to be paid by the advertiser for the set of impressions by obtaining information about an average CPM for each user in a sampling subset of the plurality of users, and by calculating, based on the average CPM for each user, an average CPM for the plurality of users. Thus, the estimated amount to be paid by the advertiser for the set of impressions comprises the average CPM for the target audience. Every online system user in the target audience has its own history, which also includes an average CPM for that online system user. In one embodiment, information about an average CPM for each online system user can be obtained from the third party system 130. In another embodiment, information about an average CPM for each online system user can be stored in a memory of the online system 140, e.g., in the user profile store 205 or in the web server 240. For example, the online system 140 retrieves information about an average CPM for each online system user from the user profile store 205 or from the web server 240. Information about an average CPM per online system user actually represents information on how expensive is to reach that particular user of the online system 140. In an embodiment, the sampling subset for computing the average CPM for the target audience includes the entire target audience for the ad campaign. In another embodiment, the sampling subset for computing the average CPM for the target audience comprises a subset of the online system users in the target audience.

The online system 140 determines 320 a second constraint of the ad campaign based on the estimated amount to be paid by the advertiser for the set of impressions served to the plurality of users (i.e., target audience). In one embodiment, the online system 140 determines 320 the second constraint of the ad campaign as a multiple of the average CPM for the plurality of users (i.e., target audience). The multiple of the average CPM for the target audience can be a fixed design choice (e.g., the multiple can be two, three, etc.). In another embodiment, the online system 140 determines 320 the second constraint of the ad campaign by first determining a scaling factor based on a variance of average CPMs obtained for all users in the sampling subset. Then, the online system 140 determines 320 the second constraint of the ad campaign by multiplying the average CPM for the plurality of users with the scaling factor to obtain the second constraint of the ad campaign. For example, if the variance of average CPMs of online system users is below a defined threshold, the scaling factor can be higher, since the online system 140 has more confidence in the target audience. On the other hand, if the variance of average CPMs of online system users is above the defined threshold, the online system 140 has less confidence in the target audience, and the online system 140 sets the scaling factor to a lower value.

The online system 140 determines 325 a pacing multiplier associated with the ad campaign that controls the budget of the ad campaign and meeting the at least one objective of the ad campaign. In some embodiments, as discussed, the pacing multiplier controls (paces) bid amounts for advertisements of the ad campaign. Pacing of bid amounts can be constrained based on a pre-defined maximum bid amount. For a given budget constraint, the online system 140 can set up a pacing multiplier such that a bid amount equal to the defined maximum bid amount is determined that would finish the budget specified by the advertiser. However, the pacing based on the maximum bid amount would reach only one constraint, i.e., either the budget would be spent or the maximum bid amount would be reached.

The online system 140 identifies 330 a plurality of impression opportunities to deliver an advertisement to the users of the online system 140. In some embodiments, an impression opportunity represents an opportunity when the online system 140 is able to serve an advertisement to an online system user. In one embodiment, an impression opportunity can be a pull opportunity, such as a page refresh, a use of a mobile application, etc. In another embodiment, an impression opportunity can be a push opportunity, such as a notification about an advertisement.

In some embodiments, for each of the impression opportunities, the online system 140 determines 335 a bid amount for the ad campaign based at least in part on the pacing multiplier factored into the bid determination 335 such that an increase in the pacing multiplier increases the bid amount and a decrease in the pacing multiplier decreases the bid amount. Determining (and modifying) 335 a bid amount of an advertisement using a pacing multiplier is further described in U.S. patent application Ser. No. 13/294,094, filed on Nov. 10, 2011, which is incorporated by reference in its entirety as stated previously.

For each of the impression opportunities, the online system 140 provides 340 the determined bid amount for the ad campaign to an advertisement selection process that selects one or more advertisements based on bids provided thereto. In some embodiments, the content selection module 235 of the online system 140 performs the advertisement selection process. The content selection module 235 selects through the advertisement selection process content for presentation to the users of the online system 140, such as one or more advertisements for presentation to the users via an impression opportunity of the identified impression opportunities. For example, the advertisement selection process is an auction based on the determined bid amount for the ad campaign and other bid amounts of advertisements from other ad campaigns. In some embodiments, the advertisement selection process ranks the advertisement from the ad campaign and advertisements from other ad campaigns based on the determined bid amount and the other bid amounts, respectively. In some embodiments, one or more advertisements having at least a threshold position in the ranking or at least a threshold bid amount are selected for presentation to the users of the online system 140.

For each of the impression opportunities, the online system 140 delivers 345 the one or more advertisements selected by the advertisement selection process to a user of the online system 140. In some embodiments, when the advertisement selection process selects the one or more advertisements for presentation, the one or more advertisements are communicated to a client device 110 for presentation to a user of the online system 140.

During a plurality of different times during the time interval of the ad campaign, the online system 140 compares 350 an amount spent under the ad campaign against the specified budget for the ad campaign specifying an amount to be paid by the advertiser for the ad campaign, to determine whether the ad campaign is on pace to reach the budget constraint. The amount spent under the ad campaign is illustrated by the spend curve 404 in FIG. 4.

During the plurality of different times during the time interval of the ad campaign, the online system 140 compares 355 an amount spent for a defined number of impressions served to the plurality of users during the ad campaign against the second constraint, to determine whether the ad campaign is on pace to reach the second constraint. In one embodiment, the online system 140 compares 355 an observed CPM over time during the time interval of the ad campaign against the second constraint. Thus, the amount spent for the defined number of impressions served to the plurality of users during the ad campaign is the observed CPM over time during the time interval of the ad campaign illustrated by the curve 402 in FIG. 4.

During the plurality of different times during the time interval of the ad campaign, the online system 140 modifies 360 the pacing multiplier based at least in part on whether the ad campaign is on pace to reach the first (budget) constraint or the second constraint (e.g., a multiple of the average CPM for the target audience). By modifying 360 the pacing multiplier, the online system 140 paces the bid amount for the advertisement based on two constraints, i.e., a budget constraint and a target-audience average CPM based constraint. In some embodiments, the online system 140 modifies 360 the pacing multiplier and the bid amount in response to each impression served for the ad campaign.

The online system 140 increases 360 the pacing multiplier to increase the bid amount when the amount spent under the ad campaign is behind pace to reach the first constraint or the amount spent for the defined number of impressions is behind pace to reach the second constraint. The online system 140 decreases 360 the pacing multiplier to decrease the bid amount when the amount spent under the ad campaign is ahead of pace to reach the first constraint or the amount spent for the defined number of impressions is ahead of pace to reach the second constraint. By increasing the bid amount for the advertisement, the online system 140 also increases an observed CPM over time during the ad campaign. The online system 140 modifies 360 the pacing multiplier and bid amounts for advertisements of the ad campaign until the observed CPM over time during the ad campaign reaches a multiple of the average CPM for the target audience. Hence, the observed CPM is constrained during the ad campaign by a defined upper bound. By increasing the bid amount for the advertisement, the online system 140 also increases the amount spent under the ad campaign. Then, at some point, either the budget constraint is within a defined budget value to be reached or a marketplace constraint based on the average CPM for the target audience is within a defined CPM value to be reached. At that time instant of the ad campaign, the online system 140 may stop modifying 360 the pacing multiplier and stops increasing a bid amount for an advertisement of the ad campaign. Thus, the online system 140 modifies 360 the pacing multiplier to increase the observed CPM over time during the ad campaign until the observed CPM reaches a first upper bound or the amount spent under the ad campaign reached a second upper bound. In an embodiment, the first upper bound is based on a multiple of the average CPM for the target audience, and the second upper bound is based on the specified budget.

In one embodiment, the online system 140 increases 360 the pacing multiplier to increase the bid amount when the observed CPM (e.g., the curve 402 shown in FIG. 4) is behind pace to reach the second constraint. In another embodiment, the online system 140 decreases 360 the pacing multiplier to decrease the bid amount when the observed CPM (e.g., the curve 402) is ahead of pace to reach the second constraint.

In various embodiments, the online system 140 effectively applies two constraints for pacing bid amounts for different advertisements during the ad campaign, i.e., a budget constraint and a constraint based on a multiple of the average CPM estimated for the target audience. The presented advertisement bidding process can be also viewed as a method for pacing bid amounts based on putting a cap on an CPM observed during a time period of the ad campaign, wherein an upper bound for the observed effective CPM is based on the multiple of the average CPM of the target audience. The constraint on the observed CPM for the ad campaign applied during the advertisement bidding process provides achieving objectives of the ad campaign specified by the advertiser even when the advertiser specifies an inappropriate budget for a target audience. The advertiser typically specifies an inappropriate budget for the ad campaign when online users in the target audience are hard to reach, the range of expected conversion events have a high variance and a low probability. In an illustrative embodiment, advertisements of the ad campaign that produce polarizing user opinions typically have a high variance of conversion rates.

### SUMMARY

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
receiving information for an advertising campaign (“ad campaign”) including a plurality of advertisements for presentation to a plurality of users of an online system, the information specifying at least one objective of the ad campaign;
receiving a first constraint of the ad campaign specifying a budget for the ad campaign specifying an amount to be paid by an advertiser for the ad campaign during a time interval of the ad campaign;
estimating an amount to be paid by the advertiser for a set of impressions served to the plurality of users;
determining a second constraint of the ad campaign based on the estimated amount;
determining a pacing multiplier associated with the ad campaign that controls the budget of the ad campaign and meeting the at least one objective of the ad campaign;
identifying a plurality of impression opportunities to deliver an advertisement to the users of the online system;
for each of the impression opportunities:
determining a bid amount for the ad campaign based at least in part on the pacing multiplier factored into the bid determination such that an increase in the pacing multiplier increases the bid amount and a decrease in the pacing multiplier decreases the bid amount,
providing the determined bid amount for the ad campaign to an advertisement selection process that selects one or more advertisements based on bids provided thereto, and
delivering the one or more advertisements selected by the advertisement selection process to a user of the online system; and
during a plurality of different times during the time interval of the ad campaign:
comparing an amount spent under the ad campaign against the specified budget for the ad campaign, to determine whether the ad campaign is on pace to reach the first constraint,
comparing an amount spent for a defined number of impressions served to the plurality of users during the ad campaign against the second constraint, to determine whether the ad campaign is on pace to reach the second constraint, and
modifying the pacing multiplier based at least in part on whether the ad campaign is on pace to reach the first constraint or the second constraint.

2. The method of claim 1, wherein modifying the pacing multiplier comprises:
increasing the pacing multiplier to increase the bid amount when the amount spent under the ad campaign is behind pace to reach the first constraint or the amount spent for the defined number of impressions is behind pace to reach the second constraint; and
decreasing the pacing multiplier to decrease the bid amount when the amount spent under the ad campaign is ahead of pace to reach the first constraint or the amount spent for the defined number of impressions is ahead of pace to reach the second constraint.

3. The method of claim 1, wherein estimating the amount to be paid by the advertiser for the set of impressions served to the plurality of users comprises:
obtaining information about an average cost per thousand impressions (CPM) for each user in a sampling subset of the plurality of users; and
calculating, based on the average CPM for each user, an average CPM for the plurality of users.

4. The method of claim 3, wherein estimating the amount to be paid by the advertiser for the set of impressions served to the plurality of users further comprises:
sampling the plurality of users into the sampling subset; and
retrieving the average CPM for each user in the sampling subset.

5. The method of claim 3, wherein determining the second constraint of the ad campaign based on the estimated amount comprises:
determining the second constraint as a multiple of the average CPM for the plurality of users.

6. The method of claim 3, wherein determining the second constraint of the ad campaign based on the estimated amount comprises:
determining a scaling factor based on a variance of average CPMs obtained for all users in the sampling subset; and
multiplying the average CPM for the plurality of users with the scaling factor to obtain the second constraint.

7. The method of claim 1, wherein modifying the pacing multiplier comprises:
modifying the pacing multiplier based at least in part on an observed cost per thousand impressions (CPM) over time during the time interval of the ad campaign.

8. The method of claim 1, wherein modifying the pacing multiplier comprises:
modifying the pacing multiplier in response to each impression served for the ad campaign.

9. The method of claim 1, wherein comparing the amount spent for the defined number of impressions served to the plurality of users during the ad campaign against the second constraint comprises:
comparing an observed cost per thousand impressions (CPM) over time during the time interval of the ad campaign against the second constraint.

10. The method of claim 9, wherein modifying the pacing multiplier comprises:
increasing the pacing multiplier to increase the bid amount when the observed CPM is behind pace to reach the second constraint; and
decreasing the pacing multiplier to decrease the bid amount when the observed CPM is ahead of pace to reach the second constraint.

11. The method of claim 1, wherein the at least one objective of the ad campaign comprises a number of impressions to be delivered to the plurality of users under the ad campaign during the time interval of the ad campaign.

12. A computer program product comprising a computer-readable storage medium having instructions encoded thereon that, when executed by a processor, cause the processor to:
receive information for an advertising campaign (“ad campaign”) including a plurality of advertisements for presentation to a plurality of users of an online system, the information specifying at least one objective of the ad campaign;
receive a first constraint of the ad campaign specifying a budget for the ad campaign specifying an amount to be paid by an advertiser for the ad campaign during a time interval of the ad campaign;
estimate an amount to be paid by the advertiser for a set of impressions served to the plurality of users;
determine a second constraint of the ad campaign based on the estimated amount;
determine a pacing multiplier associated with the ad campaign that controls the budget of the ad campaign and meeting the at least one objective of the ad campaign;
identify a plurality of impression opportunities to deliver an advertisement to the users of the online system;
for each of the impression opportunities:
determine a bid amount for the ad campaign based at least in part on the pacing multiplier factored into the bid determination such that an increase in the pacing multiplier increases the bid amount and a decrease in the pacing multiplier decreases the bid amount,
provide the determined bid amount for the ad campaign to an advertisement selection process that selects one or more advertisements based on bids provided thereto, and
deliver the one or more advertisements selected by the advertisement selection process to a user of the online system; and
during a plurality of different times during the time interval of the ad campaign:
compare an amount spent under the ad campaign against the specified budget for the ad campaign, to determine whether the ad campaign is on pace to reach the first constraint,
compare an amount spent for a defined number of impressions served to the plurality of users during the ad campaign against the second constraint, to determine whether the ad campaign is on pace to reach the second constraint, and
modify the pacing multiplier based at least in part on whether the ad campaign is on pace to reach the first constraint or the second constraint.

13. The computer program product of claim 12, wherein modify the pacing multiplier comprises:
increase the pacing multiplier to increase the bid amount when the amount spent under the ad campaign is behind pace to reach the first constraint or the amount spent for the defined number of impressions is behind pace to reach the second constraint; and
decrease the pacing multiplier to decrease the bid amount when the amount spent under the ad campaign is ahead of pace to reach the first constraint or the amount spent for the defined number of impressions is ahead of pace to reach the second constraint.

14. The computer program product of claim 12, wherein estimate the amount to be paid by the advertiser for the set of impressions served to the plurality of users comprises:
obtain information about an average cost per thousand impressions (CPM) for each user in a sampling subset of the plurality of users; and
calculate, based on the average CPM for each user, an average CPM for the plurality of users.

15. The computer program product of claim 14, wherein estimate the amount to be paid by the advertiser for the set of impressions served to the plurality of users further comprises:
sample the plurality of users into the sampling subset; and
retrieve the average CPM for each user in the sampling subset.

16. The computer program product of claim 14, wherein determine the second constraint of the ad campaign based on the estimated amount comprises:
determine the second constraint as a multiple of the average CPM for the plurality of users.

17. The computer program product of claim 14, wherein determine the second constraint of the ad campaign based on the estimated amount comprises:
determine a scaling factor based on a variance of average CPMs obtained for all users in the sampling subset; and
multiply the average CPM for the plurality of users with the scaling factor to obtain the second constraint.

18. The computer program product of claim 12, wherein modify the pacing multiplier comprises:
modify the pacing multiplier in response to each impression served for the ad campaign.

19. The computer program product of claim 12, wherein compare the amount spent for the defined number of impressions served to the plurality of users during the ad campaign against the second constraint comprises:
compare an observed cost per thousand impressions (CPM) over time during the time interval of the ad campaign against the second constraint.

20. The computer program product of claim 19, wherein modify the pacing multiplier comprises:
increase the pacing multiplier to increase the bid amount when the observed CPM is behind pace to reach the second constraint; and
decrease the pacing multiplier to decrease the bid amount when the observed CPM is ahead of pace to reach the second constraint.
